(19) United States
(12) Patent Application Publication
(10) Pub. No.: US 2005/0180257 A1
(43) Pub. Date: Aug. 18, 2005

(54) MANUAL EGGBEATER

(76) Inventor: Jung-Ching Peng, Taichung Hsien (TW)

Correspondence Address: Leong C. LEI;PMB#1008, 1867 Ygnaclo Valley Road, Walnut Creek, CA, 94598, US

(21) Appl. No.: 10/778,095

(22) Filed: Feb. 17, 2004

(51) Int. Cl. A23L 1/00

(52) U.S. Cl. 366/129

(57) ABSTRACT

A manual eggbeater including a rotator, a gear set, a gear thrust rod, an elastic press rod, and a handle; the rotator related to a strip metal having its frond end to pass through the handle and incorporated to an output gear in the gear set; the elastic press rod being compressed to advance to drive the gear thrust rod to drive the gear set to rotate; the elastic press rod being released to pull the gear thrust rod back to its initial position in cycle; linear energy generated by the gear thrust rod being converted into fast rotation energy through the arrangement of multiple gears in the gear set and gear ratio; and the rotation energy driving the rotator to fast rotate in a given direction.

### BACKGROUND OF THE INVENTION

(a) Technical Field of the Invention

The present invention is related to an improved structure of a manual eggbeater, and more particularly, to one that allows fast and agile egg beating by taking the drive from the pressure executed inwardly by the palm of the user.

(b) Description of the Prior Art

Whereas the rotary eggbeaters generally available in the market rely upon a motor as the drive power, its production cost is higher, larger in dimension, and needs the access to a power source at the expenses of being convenient and agile.

### SUMMARY OF THE INVENTION

The primary purpose of the present invention is to provide an improved structure of a manual eggbeater that operates by using the pressure internal exercised by the palm to convert linear energy into fast rotation energy to drive a rotator to fast rotate in a given direction. To achieve the purpose, the present invention is comprised of a rotator, a gear set, a gear thrust rod, an elastic press rod, and a handler. The rotator relates to a strip metal having its front end passed through the handle to be incorporated with an output gear in the gear set. By pressing a palm of the user inwardly against the elastic press rod to drive the gear thrust rod, thus to drive gears inside the gear set to rotate, and then the elastic press rod pulls the thrust rod back to its initial position allowing a space for the gear thrust rod to advance in cycle. Consequently, the linear energy from the gear thrust rod is converted into fast rotation energy through the arrangement of the gears inside the gear set and the gear ratio for driving the rotator to fast rotate in beating the egg.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a manual eggbeater of the present invention.

FIG. 2 is a positional view of the present invention.

FIG. 3 is a schematic view showing the present invention in use.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention related to a manual eggbeater is essentially comprised of a rotator, a gear set, a gear thrust rod, an elastic press rod, and a handle.

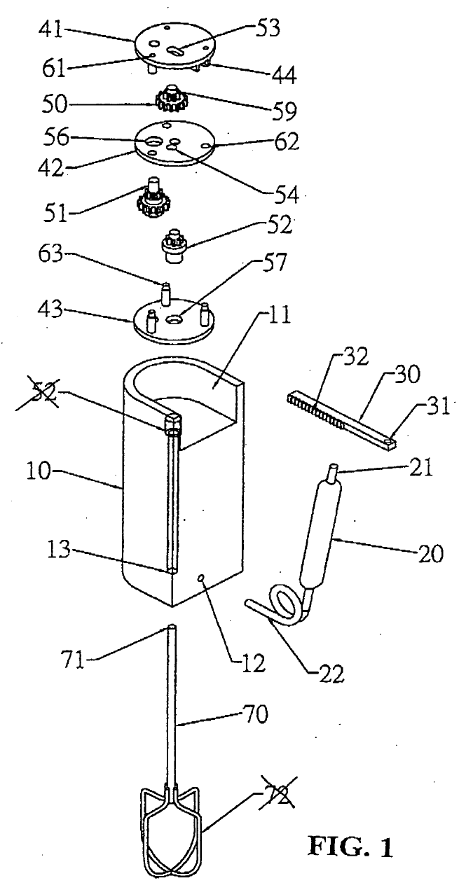

Referring to FIG. 1, the gear set (40) is inserted into an accommodation space (11) inside the handle (10). Wherein, the rotator (70) is related to a strip metal with its front end (71) passing through a hole (13) on the (10) to be connected to an output gear (52). The output gear (52) passes through a center (57) on a lower position (43) of the gear set (40) to be incorporated with a transmission gear (51) before passing through a hole (56) provided on a central position (42) of the gear set (40) to further engage with a drive gear (50). A locking rod (59) disposed at the upper end of the drive gear (50) is inserted into a rectangular locking hole (53) provided in the upper position (41) of the gear set (40); and another locking rod (591) disposed at the lower end of the drive gear (50) is inserted into another rectangular hole (54) disposed in the central position (42) of the gear set (40) for the drive gear (50) to rotate in a space defined by the upper position (41) and the central position (42) of the gear set (40), and to advance or retreat therein due to both locking rectangular holes (53, 54). The upper position (41), the central position (42), and the lower position of the gear set (40) are secured to one another by having three locking screws (60) to respectively pass through a set of three holes (61) disposed on the upper position (41) of the gear set (40), and another set of three holes (62) disposed on the central position (42) of the gear set (40) to be engaged into a set of three corresponding locking studs (63) erected from the surface of the lower position (43) of the gear set (40) to complete an assembly of the gear set (40).

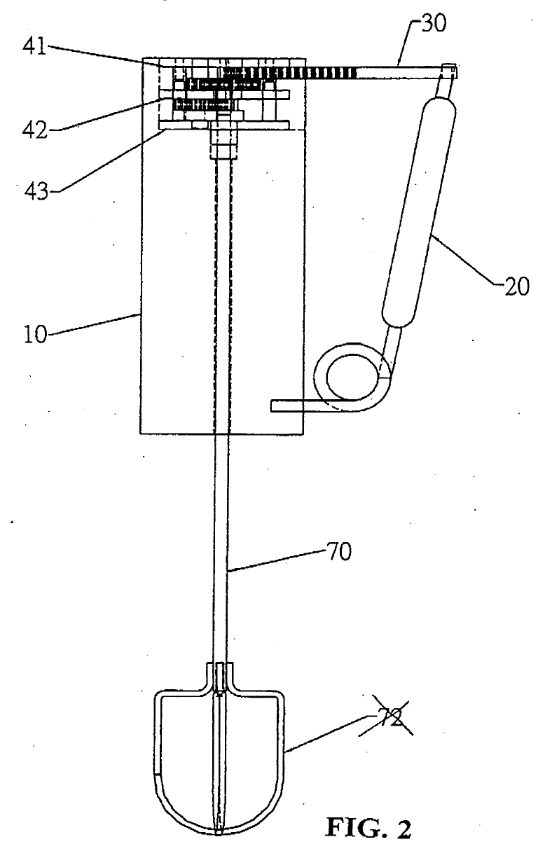

Now referring to FIG. 2 for a sectional view of the manual eggbeater of the present invention. Wherein, the gear set (40) is secured in the accommodation space inside the handle (10). The gear thrust rod (30) is inserted into a slide groove (44) provided on the upper position (41) of the gear set (40) to allow multiple teeth (32) of the gear thrust rod (30) to be engaged to those teeth provided on the top of the drive gear (50). The lower part (22) of the elastic press rod (20) is inserted into and secured in a locking hole (12) provided on the bottom of the handle (10. Another shorter strip metal (21) provided on the top of the elastic press rod (20) is inserted into a hole (31) provided to the right of the gear thrust rod (30) for the handle (10), the gear set (40), the gear thrust rod (30) and the elastic press rod (20) to become an integrated part. A front end (71) of the rotator (70) is then inserted into the output gear (52) to complete the combination of linear energy and rotation energy. Once the elastic press rod (20) is inwardly pressed, it advances to push the drive gear (50) to be incorporated with the transmission gear (51) and the output gear (52) for the output gear (52) to rotate and drive the rotator (70) to rotate.

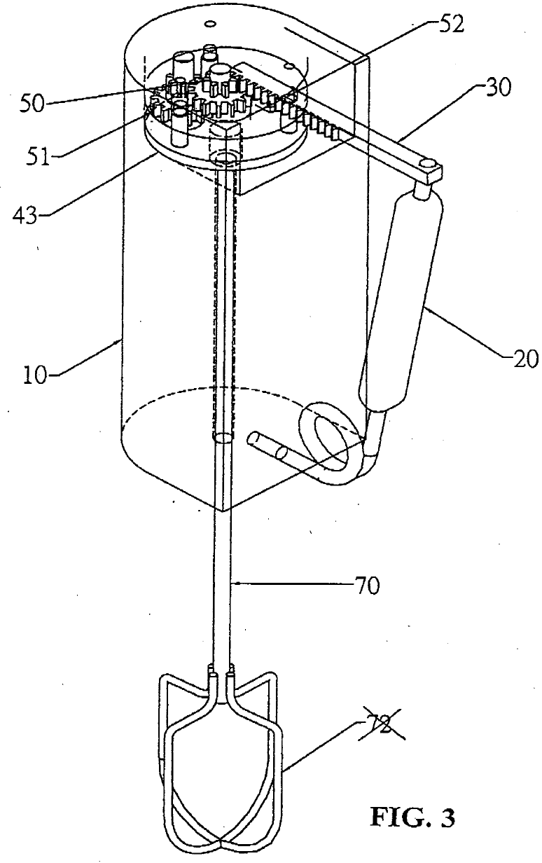

The manual eggbeater of the present invention is convenient and agile, and allows lower production cost. As illustrated in FIG. 3 for a schematic view showing the operation of the manual eggbeater of the present invention, wherein, the user holds the handle (10) and press it inwardly to advance the elastic press rod (20) to drive the gear thrust rod (30) for rotating multiples gears inside the gear set (40) to rotate, thus to drive the rotator (70) to drive by means of the rotating output gear (52). When the elastic press rod (20) is released and returned to its initial position, it pulls the gear thrust rod (30) back to its initial position for ready to advance again.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. (canceled)

2. A structure of a manual eggbeater comprising a rotator, a gear set, a gear thrust rod, an elastic press rod, and a handle, wherein the rotator is made of a strip metal, a front end of the strip metal passing through the handle and incorporated to an output gear in the gear set, the elastic press rod being compressed to advance to drive the gear thrust rod to drive the gear set to rotate, the elastic press rod being released to pull the gear thrust rod back to its initial position, linear energy generated by the gear thrust rod being converted into fast rotation energy through arrangement of multiple gears in the gear set and gear ratio, and rotation energy driving the rotator to fast rotate in a given direction.
